(19) United States
(12) Patent Application Publication
(10) Pub. No.: US 2022/0308355 A1
(43) Pub. Date: Sep. 29, 2022

(54) STRIPED MIRROR IMAGE SPLITTER

(71) Applicant: MSG Entertainment Group, LLC, New York, NY (US)

(72) Inventor: Eric P. SAGOTSKY, Los Angeles, CA (US)

(73) Assignee: MSG Entertainment Group, LLC, New York, NY (US)

(21) Appl. No.: 17/209,595

(22) Filed: Mar. 23, 2021

(51) Int. Cl. G02B 27/10; G02B 27/14

(52) U.S. Cl. CPC G02B 27/106; G02B 27/141

(57) ABSTRACT

Disclosed herein are system and product embodiments for an optical image splitter with a plurality of triangular image splitters including a plurality of reflective patterns interleaved with a plurality of transmissive patterns and configured to split an image into a plurality of reflected image portions and a plurality of transmitted image portions. The plurality of reflected and transmitted image portions are subsequently split by additional reflective patterns interleaved with a plurality of transmissive patterns and captured by sensors as partial images to be subsequently recombined to form an image.

### BACKGROUND

When pixel density of a camera becomes high relative to sensor size, an overall size of an image capture sensor may be increased to maintain favorable noise and low light capture characteristics. However, large optical sensors, such as CCD (charge-coupled device) and CMOS (complementary metal-oxide semiconductor) are difficult to produce and are very expensive. By combining a number of smaller sensors, all behind the same lens, a composite larger sensor can be constructed. Ideally, these smaller sensors would all be tiled directly edge-to-edge with the last row of pixels on one sensor lining up perfect with the first row on the next sensor. However, most modern sensors are manufactured to have an active sensor area and some amount of non-active bezel for sensor mounting and ancillary sensor processing electronics. This bezel prevents two sensors from sitting directly next to each other in the same plane without there being a significant gap in the combined image.

### BRIEF DESCRIPTION OF THE DRAWINGS/FIGURES

FIG. 1A depicts a triangular image splitter with vertical reflective striping, according to some embodiments.

FIG. 1B depicts a triangular image splitter with horizontal reflective striping, according to some embodiments.

FIG. 1C depicts a triangular image splitter with a sensor array, according to some embodiments.

FIG. 2 depicts a block diagram of splitting light with a triangular image splitter with reflective striping, according to some embodiments.

FIG. 3 depicts a block diagram of a system for splitting images, according to some embodiments.

FIG. 4 depicts another block diagram of a system for splitting images to multiple sensors, according to some embodiments.

FIG. 5 depicts an illustration of an example reflect-reflect partial image capture, according to some embodiments.

FIG. 6 depicts an illustration of an example reflect-transmit partial image capture, according to some embodiments.

FIG. 7 depicts an illustration of an example transmit-reflect partial image capture, according to some embodiments.

FIG. 8 depicts an illustration of an example transmit-transmit partial image capture, according to some embodiments.

FIG. 9 depicts an illustration of an example segmented image, according to some embodiments.

FIG. 10A depicts an illustration of an example reflect-reflect segmented partial image capture, according to some embodiments.

FIG. 10B depicts an illustration of an example reflect-transmit segmented partial image capture, according to some embodiments.

FIG. 10C depicts an illustration of an example transmit-reflect segmented partial image capture, according to some embodiments.

FIG. 10D depicts an illustration of an example transmit-transmit segmented partial image capture, according to some embodiments.

FIG. 11 depicts an illustration of a system for splitting images to multiple sensors, according to some embodiments.

FIG. 12 depicts another illustration of a system for splitting images to multiple sensors, according to some embodiments.

FIGS. 13A-13D depict sensor array arrangements for a system splitting images to multiple sensors, according to some embodiments.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or product embodiments, and/or combinations and sub-combinations thereof, for an optical image splitter with a plurality of optical image splitters. Each of the optical image splitters include a plurality of reflective mirror patterns interleaved with a plurality of transmissive areas, and are configured to split an image into a plurality of reflected image portions and a plurality of transmitted image portions. These image portions are subsequently split into a plurality of additional reflected and transmitted image portions. These additional image portions are captured by optical sensors as partial images to be subsequently recombined to form the image.

A digital camera is a camera that captures photographs in digital memory. Most cameras produced today are digital, largely replacing those that capture images on photographic film. Digital and digital movie cameras share an optical system, typically using a lens with a variable aperture to focus light onto a sensor located in a body of the camera. The aperture and shutter admit the correct amount of light to the image, just as with film, but the image pickup device is electronic rather than chemical. The image sensor can be a single sensor or a plurality of sensors where each sensor captures at least a portion of the image that is subsequently stored in digital memory.

Where a plurality of sensors are employed, post processing methods stitch the partial images back together using known image processing techniques. However, most modern sensors include a non-active bezel for sensor mounting that prevents two sensors from sitting directly next to each other in the same plane without there being a significant gap in the combined image. The technology described herein segments the image into multiple portions using an optical image splitter device that includes a plurality of glass image splitters. As the image is split a plurality of times, non-contiguous portions of the image are directed to sensors arranged in common sensor planes configured around a perimeter of the optical image splitter device. Capturing non-contiguous portions in a common plane eliminates gaps in the combined image as will be discussed in greater detail hereafter.

To create a seamless image across multiple sensors, the technology described herein redirects portions of the image to different planes such that two sensors capturing adjacent areas of the image are not overlapping in physical space. In the various embodiments described herein, geometric portions (e.g., stripes or rectangular patterns) of reflective surfaces (coatings), less than the entire image, can be inserted into an image-forming light path so that some portions of the light are reflected while the remaining portions can pass through (transmitted). By using mirrored surfaces (substantially 100% reflection), rather than prior art 50% transmissive reflective mirrors, light loss can be reduced throughout the system. By attaching the reflective mirror surfaces to transparent glass shapes (e.g., glass blocks), the mirror edge results in an almost seamless transition from one sensor to the next.

As described herein, “front” refers to the lens side and “back” refers to a side further from the lens. Angles listed assume that the optical axis of the lens is at 0 degrees. Angles are all referring to rotation in the horizontal plane. Throughout the descriptions, figures and claims the terms “transmit” and “pass-through” may be used interchangeably. In addition, throughout the descriptions, figures and claims the terms “clear”, “transparent” and “transmissive” may be used interchangeably. For purposes of simplicity, vertical stripe (VS) patterns (reflective and transmissive) are numbered right-to-left (VS1-VS4) and horizontal stripe (HS) patterns numbered top-to-bottom (HS1-HS4).

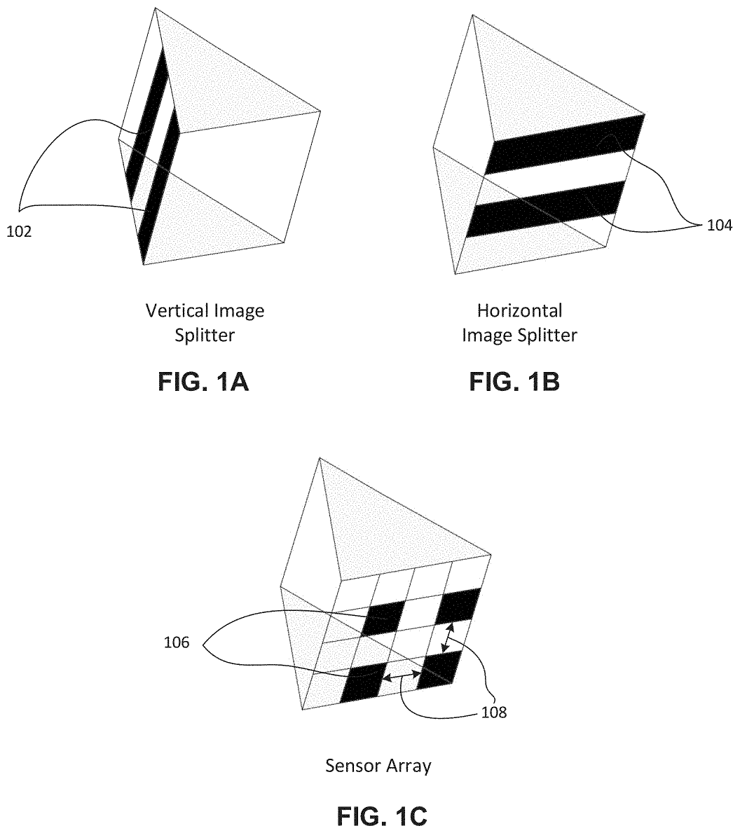

FIGS. 1A-1C illustrate various triangular shaped glass structures used throughout the various embodiments described herein. FIG. 1A depicts a first triangular image splitter with vertical reflective patterns (striping) 102, according to some embodiments. This triangular image splitter splits an incident image into two or more vertical sections. Vertical reflective (mirror) patterns may be arranged in various configurations on one or more vertical surfaces of legs of a triangular shaped glass structure (e.g., shown in second and fourth quarters of first leg of the shape). The vertical reflective patterns alternate with equal sized transmissive patterns as will be discussed in greater detail hereafter.

FIG. 1B depicts a triangular image splitter with horizontal reflective (mirror) patterns, according to some embodiments. Horizontal reflective patterns 104 may be arranged in various configurations (e.g., shown in first and third quarters of one leg of a triangular glass structure) as long as the vertical reflective patterns alternate with equal sized transmissive patterns. This triangular image splitter splits an incident image into two or more horizontal sections.

FIG. 1C depicts a triangular shaped glass block with an attached sensor array, according to some embodiments. One or more sensors 106 (e.g., array) are integrated into a printed circuit board (PCB) and connected to an outer face of a triangular shaped glass structure to capture the N image-forming portions impinging on the sensors. The sensors have a bezel size that is less than one-half of the active sensor area. The sensors are mounted to the board (not shown) such that the spacing 108 edge-to-edge between sensors is slightly less than the active area of the sensor. Alternatively, the sensors could be glued to the glass structure and then wired to a PCB.

In one example embodiment, the image is first split by spaced vertical reflective stripes and then split by multiple sets of spaced horizontal reflective stripes. In this embodiment, multiple distinct planes are available for partial image captures allowing these sensors to be scaled horizontally and vertically without ever occupying the same physical space. Any sensor with a bezel that is less than approximately one-half the active area can be used to make as large of an array as desired with no gap appearing between adjacent image areas. The contiguous bezels, when added together between two sensors, need to be less than the active area of the sensor.

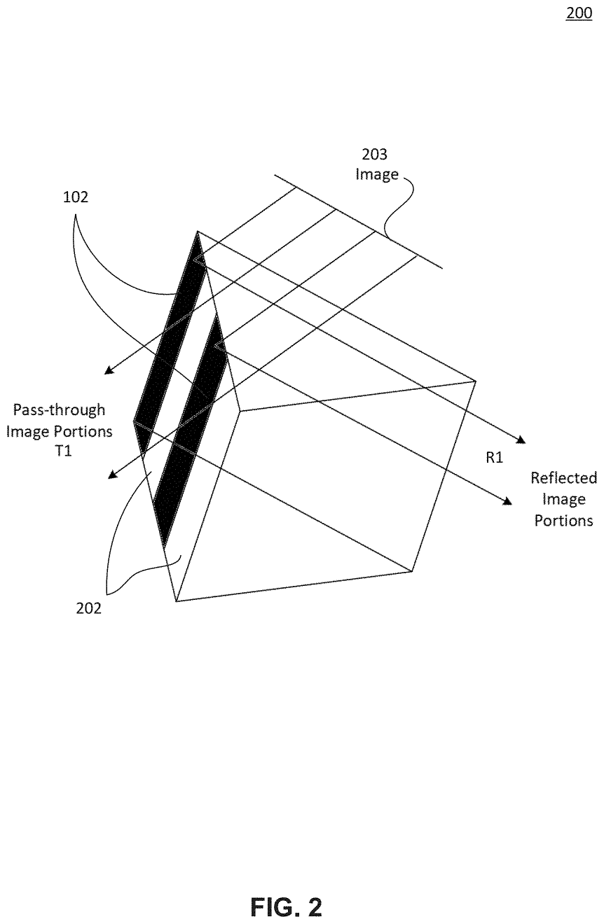

FIG. 2 depicts a triangular image splitter 200 with vertical reflective striping 102, according to some embodiments. Image splitter 200 is illustrated in three dimensions with reflected and transmitted optical image portions. For illustration purposes only, the optical paths are shown as straight single vectors of light. Image splitter 200 is a transparent (e.g., glass) isosceles right triangular shape with one-half of a hypotenuse length that matches a desired width of an image and a height that matches a desired height of the image. In one embodiment, the reflective stripes between the different stages are scaled up as they move further from the nodal point of the lens. For example, the first stripes are closer together than the next set of stripes as the image expands moving away from the lens.

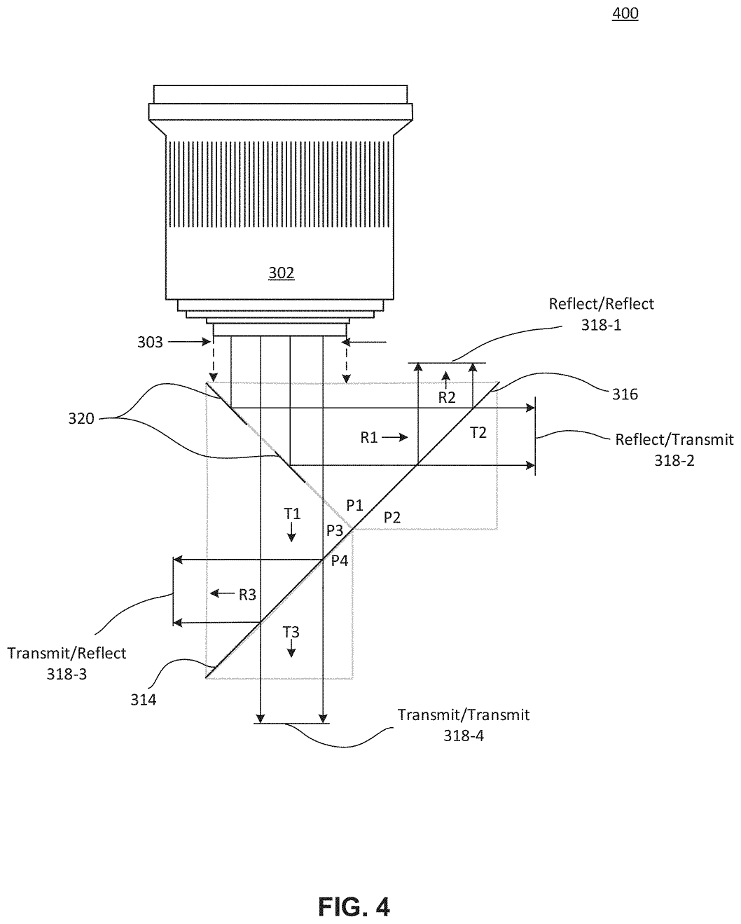

An image plane 203, emanating as an image from the back of a camera lens, is split into multiple optical paths. For illustration purposes only, the optical paths are shown as four (4) straight single vectors of light. However, as will be shown in FIGS. 4-8, the image, in practice, is split into various geometric patterns (image portions) as the optical path is split a plurality of times, in multiple directions, to form on multiple sensor arrays, located in multiple planes.

The image passes through the left leg of the structure with portions incident on vertical mirror stripes 102 being reflected (R1) towards the right leg of the structure and portions incident on vertical alternating transmissive (clear) areas 202 being transmitted (T1).

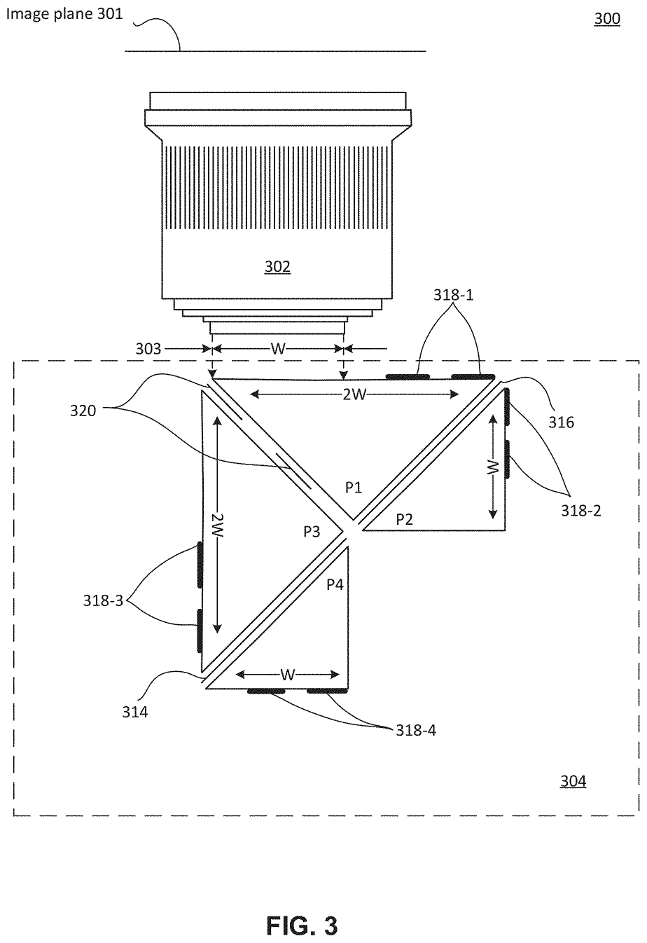

FIG. 3 depicts a block diagram of a system 300 for splitting images, according to some embodiments. Camera lens 302 and camera 304 are physically and optically coupled to one another. Images from image plane 301 enter a front of the lens and exit from the back. Different camera lenses 302 can be interchangeably paired with camera 304 without departing from the scope of the technology described herein. For example, camera lenses as described herein include, but are not limited to lenses of varying focal length ranges, such as standard lenses, specialty lenses, wide-angle, telephoto, zoom, macro, fish-eye, etc. In addition, camera lens 302 can contain a single lens or combination of multiple lenses within its housing.

Camera 304 may be any digital, digital high resolution or digital ultra-high resolution camera without departing from the scope of the technology described herein. For example, camera 304 can include, and/or can be integrated as part of, but is not limited to a DSLR (digital single-lens reflex), a DTLR (digital twin-lens reflex), video, 3D (three-dimensional), compact, smartphone, mirrorless, action (adventure), panoramic (180-360 degrees) camera, etc. While the various embodiments described are specifically directed to visible light applications, non-visible (e.g., infrared or thermal) imaging components may be interchanged without departing from the scope of the technology described herein.

To create a seamless image across multiple sensors, the technology described herein redirects portions of the image to different planes using a collection of three-dimensional triangular glass shapes (e.g., P1, P2, P3 and P4) located within the camera body 304. However, those skilled in the relevant art(s) will recognize that other numbers of triangular shapes are possible without departing from the scope of the technology described herein. For example, those skilled in the relevant art(s) can readily apply the teaching herein to any suitable number of triangular shapes, without departing from the scope of the technology described herein. The collection comprises two similar sized isosceles triangles shapes P1 and P3 and two smaller similar sized isosceles triangle shapes P2 and P4. While the triangular shapes are shown in a one-dimensional top view, each triangular shape (P1-P4) is three-dimensional (e.g., as shown in FIGS. 1A-1C and FIG. 2) with a height equal to a desired image height of an image emanating from lens 302. In an alternate embodiment, the triangular shapes can face different directions. For example, one reflects towards the top or towards the bottom rather than left and right.

Lens 302 receives an image from image plane 301 and outputs an image 303 (width W) as an image from the back of the lens. A transparent isosceles right triangular shape P1, with a hypotenuse length of twice the width (2W) of image 303 and a height that matches a desired height of the image, is placed behind the lens 302. P1 is vertically centered, but horizontally shifted with the optical axis of the lens (center of the lens 302) falling approximately one-quarter of the way across the hypotenuse of the triangular shape.

A first image splitter is applied to one leg of P1. The first image splitter includes one or more vertical mirrored (reflective) layer patterns 320 formed on a vertical surface of a near leg of the isosceles right triangle P1, approximately 315 degrees from the lens. The one or more mirrored (reflective) layer patterns 320 are spaced across the vertical surface by an equal number of similar sized transmissive patterns. For example, a two-stripe embodiment would include two reflective patterns interleaved with two transmissive sections (no reflection) of the same size and shape (see FIG. 1A). For illustration purposes only, the stripes are depicted as separated from the P1 surface. However, in practice they are formed directly on the surface through a known coating process, such as lithography, vacuum deposition or other known methods.

A second image splitter is applied to a second leg of P1. The second image splitter includes one or more mirrored (reflective) layers with alternating same sized clear (transmissive) areas formed as horizontal mirror stripes 316 on a vertical surface of a far leg of the isosceles right triangle P1 (see FIG. 1B), 45 degrees from the optical axis of the lens and 90 degrees offset from the vertical mirror stripes 320. For illustration purposes, the stripes are depicted as separated from the P1 surface. However, in practice they are formed directly on the surface through a coating process, such as lithography, vacuum deposition or other known methods.

A first smaller (leg width W) isosceles right triangle P2 with a hypotenuse length matching the second leg length of P1 and a height matching the height of P1 is adhered to horizontal stripes 316. One leg of P2 is parallel to the optical axis of the lens while the other is perpendicular.

An isosceles right triangle P3, the same size/shape as P1, has a near leg adhered to an outward surface of reflective patterns 320. The far leg of P3 is located at a 45 degree angle to the optical axis of the lens. One or more horizontal mirrored layers 314 are formed on a back vertical surface of the far leg as horizontal mirror stripes spaced across the surface with alternating transmissive areas. The one or more mirrored (reflective) layer patterns 320 are spaced across the vertical surface by an equal number of similar sized transmissive patterns. For example, a two-stripe embodiment would include two reflective patterns interleaved with two transmissive sections (no reflection) of the same size and shape (see FIG. 1B). These horizontal mirrored stripes are formed on the far leg face of the isosceles right triangle 45 degrees from the optical axis of the lens and 270 degrees offset from the vertical mirror stripes 320.

A second smaller isosceles right triangle P4 with a hypotenuse length matching the far leg length of P3 and a height matching the height of P3 is adhered to horizontal stripes 314. One leg of P4 is parallel to the optical axis of the lens, the other is perpendicular. The perpendicular face is collinear with the back element of the lens. The reflective patterns (mirrors) and spaces may need to be scaled up in size as they move further away from the lens as the rays coming from the lens may have some divergence (i.e., not perfectly collimated).

Sensors 318 (1-4) are located in four planes on outside surfaces of P1-P4, as described in greater detail hereafter, and include N sensors, where N equals the number of reflective patterns (mirrored stripes) plus the number of alternating transmissive patterns. Each of the four planes includes an array of N sensors. For example, a four stripe (two reflective stripe patterns and two transmissive stripe patterns) configuration would include four arrays of four sensors in each of the four planes for a total of 2^{N} (2²=16) sensors.

While a 16 sensor array is pictured throughout the drawings, including image splitters with 2 mirrored stripe patterns and two transparent stripe patterns, the design can scale to any N×N number of sensors by adding more mirrored and transparent stripe patterns (in equal numbers). Likewise, the number of sensors can be scaled down to fewer sensors using fewer mirrored and transparent stripe patterns.

Imaging sensors 318 (1-4) as typically found in digital cameras include CCD (charge-coupled device) or CMOS (complementary metal-oxide semiconductor) devices. However, any high-resolution sensor can be substituted for image sensors 318 (1-4), to include visible light sensors or non-visible radiation sensors (infrared or thermal) without departing from the scope of the technology described herein. For example, in one embodiment, the disclosed image splitters could be used in conjunction with a traditional 50% transmissive reflective image splitter to achieve a multi spectral image with infrared going through one path and visible light going through the other.

In addition, while shown as multiple sensors in FIG. 3, the sensors can be arranged as separate single sensors, sensor pairs or sensor arrays without departing from the scope of the technology disclosed herein. A discussion of placement of sensors provided hereafter includes terms “near” and “far” that represent locations relative to the back of lens 302.

One or more sensors 318-1 (e.g., an array) are connected in a first plane to a far front face of the hypotenuse of P1. Sensors described throughout the descriptions may be applied directly to P1-P4 surfaces or included as part of a printed circuit board (PCB) containing the sensor and associated electronics and are connected using, for example, solder paste or other known mounting method. The sensors have a bezel size that is less than one-half of the active sensor area. In an alternative example, when all sensors are mounted in the same direction, the bezel can be uneven as long as it is less than ½ the active area.

An array of any number of sensors can be used in this design. Four (4) sensors per board yields a combined system with 16 sensors (as pictured). The sensors are mounted to the board such that the vertical spacing edge-to-edge between sensors is slightly less than the vertical height of the active area of the sensor. It should be noted that this is just one configuration of this camera system. Other configurations where the sensors are mounted on the top or bottom face of the camera and the mirrors reflect at a 45 degree angle running from the bottom to the top of the camera are also possible using this same core principals as described herein. The sensors are justified to the top left corner of P1.

One or more sensors 318-2 (e.g., an array) are connected in a second plane (perpendicular to the first plane) to a near end face of the parallel leg of P2. The sensors have a bezel size that is less than one-half of the active sensor area. An array of any number of sensors can be used in this design. Four (4) sensors per board yields a combined system with 16 sensors (as pictured). The sensors are mounted to the board such that the vertical spacing edge-to-edge between sensors is slightly less than the vertical height of the active area of the sensor. The sensors are justified to the bottom right corner of P2.

One or more sensors 318-3 (e.g., an array) are connected in a third plane (perpendicular to the first plane and parallel to second plane) on a far end face of the hypotenuse of P3. The sensors have a bezel size that is less than half of the active sensor area. An array of any number of sensors can be used in this design. Four (4) sensors per board yields a combined system with 16 sensors (as pictured). The sensors are mounted to the board such that the vertical spacing edge-to-edge between sensors is slightly less than the vertical height of the active area of the sensor. The sensors are justified with the bottom left sensor lining up one-half way across the hypotenuse of P3 along the bottom edge.

One or more sensors 318-4 (e.g., an array) are connected in a fourth plane (parallel to the first plane and perpendicular to second plane) on a far end face of the parallel leg of P4. The sensors have a bezel size that is less than half of the active sensor area. An array of any number of sensors can be used in this design. Four (4) sensors per board yields a combined system with 16 sensors (as illustrated). The sensors are mounted to the board such that the vertical spacing edge-to-edge between sensors is slightly less than the vertical height of the active area of the sensor and mounted directly opposite the lens. The sensors are justified to the top right corner of P4.

Once the portions are captured on respective sensors they need to be combined to recreate the original image. Images portions that incur orientation changes, such as occurring during reflection, are reoriented to their original orientation. The image portions are then stitched together using image-processing techniques and subsequently stored in digital memory. Image stitching or photo stitching is the process of combining multiple photographic images with overlapping fields of view to produce a segmented panorama or high-resolution image. Commonly performed through the use of computer software, most approaches to image stitching require nearly exact overlaps between images and identical exposures to produce seamless results. Some digital cameras can stitch their photos internally.

While specific embodiments described herein cite specific arrangements of three-dimensional transparent structures and sensors, variations in transparent structures (e.g., shape, size, index of refraction, etc.), associated sensors and their respective arrangements are considered within the scope of the technology described herein using known optics principles.

In one alternate example embodiment, P1 can split the image into horizontal portions first followed by subsequent splitting into vertical portions without departing from the scope of the technology described herein.

FIG. 4 depicts another block diagram of a system 300 for splitting an image to multiple sensors, according to some embodiments. As shown, P1-P4 and reflecting stripe patterns are optically connected with image 303 emanating from the back of a camera lens 302 and successively split into multiple optical paths. For illustration purposes only, the optical paths are shown as straight single vectors of light. However, as will be shown in FIG. 4 and FIGS. 5-8, the image, in practice, is split into various geometric patterns as the optical path is split a plurality of times, in multiple directions, to form on multiple sensor arrays, located in multiple planes.

A combination structure is illustrated that includes a plurality of glass blocks adhered together allowing an image (or portion) to be transmitted through the entire combination. Image 303 passes through the left leg of P1 with those portions incident on vertical mirror stripes 320 being reflected (R1) towards the right leg of P1 and portions incident on vertical alternating clear (transmissive) areas being transmitted (T1) (passed through) towards P3.

In a two (2) stripe embodiment, a first (left) vertical quarter image portion and a third vertical quarter image portion are reflected (R1). As a consequence, a total of one-half of the image arrives incident on a right leg surface of P1. The remaining one-half of the image is transmitted (T1) as a second quarter image portion and a fourth quarter image portion to a first leg of P3.

The reflected (R1) first vertical quarter image portion and the third vertical quarter image portion are subsequently reflected (R2) as they become incident on horizontal mirror stripes 316 as four non-contiguous image portions towards four sensor array 318-1 (shown as a reflect-reflect sensor). As such, a first total of one-quarter of the image is captured on these four separate sensors, one-sixteenth of the image each.

The reflected (R1) left vertical quarter image portion and the second vertical quarter image portion are also incident on alternating clear (transmissive) areas and are transmitted (T2) (passed through) as four non-contiguous image portions towards four sensor array 318-2 (shown as a reflect-transmit sensor). As such a second total of a one-quarter of the image is captured on these 4 sensors, one-sixteenth of the image each.

The second vertical quarter image portion and a fourth vertical quarter image portion are transmitted (T1) to P3 as they pass through the clear transmissive stripe patterns as the remaining half of the image. The second vertical quarter image portion and the fourth vertical quarter image portion are subsequently reflected (R3) as they become incident on horizontal mirror stripes 320 as four non-contiguous image portions towards four sensor array 318-3 (shown as a transmit-reflect sensor). As such, a third total of one-quarter of the image is captured on these four sensors, one-sixteenth of the image each.

The second (middle) vertical quarter image portion and a fourth (right) vertical quarter image portion are transmitted (T3) to P4 as they pass through the clear transmissive stripe patterns alternating with horizontal stripes 314 as the remaining half of the image. The second vertical quarter image portion and the fourth vertical quarter image portion are subsequently reflected (T3) as they become incident on horizontal mirror stripes 320 as four non-contiguous image portions towards four sensor array 318-4 (shown as transmit-transmit sensor). As such, a third total of one-quarter of the image is captured on these four sensors, one-sixteenth of the image each.

The combination arrangements illustrated in FIG. 4 are similar to cube beam splitters as they each form tunnels. A ray starts outside of a transparent structure and enters via one of the faces. The ray continues straight through the next cross-section without changing its original direction through the first cross-section, then the light will pass through this surface and exit the transparent structure.

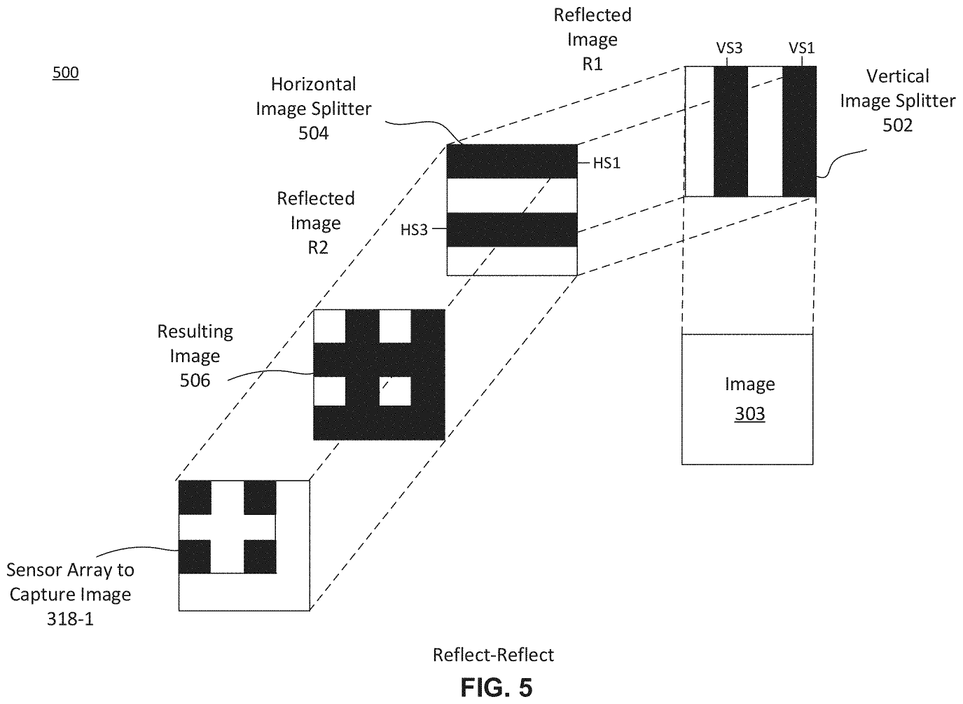

FIG. 5 depicts an illustration of an example reflect-reflect partial image capture, according to some embodiments. An image path includes various splitters (located on transparent structures as described in association with FIGS. 1A, 1B and 2) where it is split by reflection or transmission. In the example embodiment, a plurality of four stripe splitters (two reflective stripes and two transmissive stripes) segment the image into 16 partial images (squares). Four sensor arrays each capture four of the sixteen partial images (squares) as will be discussed in greater detail hereafter.

As shown, an optical path is formed from image 103 emanating from the back of a camera lens (not shown) to a sensor array 318-1 with two reflection phases R1 and R2, as shown in FIG. 3 and FIG. 4.

Image 303 is incident on a surface of vertical image splitter 502. The function of this splitter is to split the image into four vertical image portions. However, only image portions incident on two reflective vertical stripe patterns 320 (VS1 and VS3) are reflected from the splitter and form a first reflected image R1. In this case, when reflected, the image is flipped on the vertical axis, as is known.

Reflected vertical stripe image portions (VS1 and VS3) are subsequently split as they become incident on horizontal image splitter 504. However, only image portions incident on the two reflective horizontal stripe patterns (HS1 and HS3) reflect from the splitter and form a resulting reflected image R2. As with before, when reflected, the image is flipped on the vertical axis returning it to its original orientation.

Each of the four resulting image portions shown as resulting image 506 are based on the intersection of VS1 and VS3 with HS1 and HS3. These four images are formed on sensor array 318-1. As such, a total of a quarter of the image is captured on these four sensors, one-sixteenth of the image each.

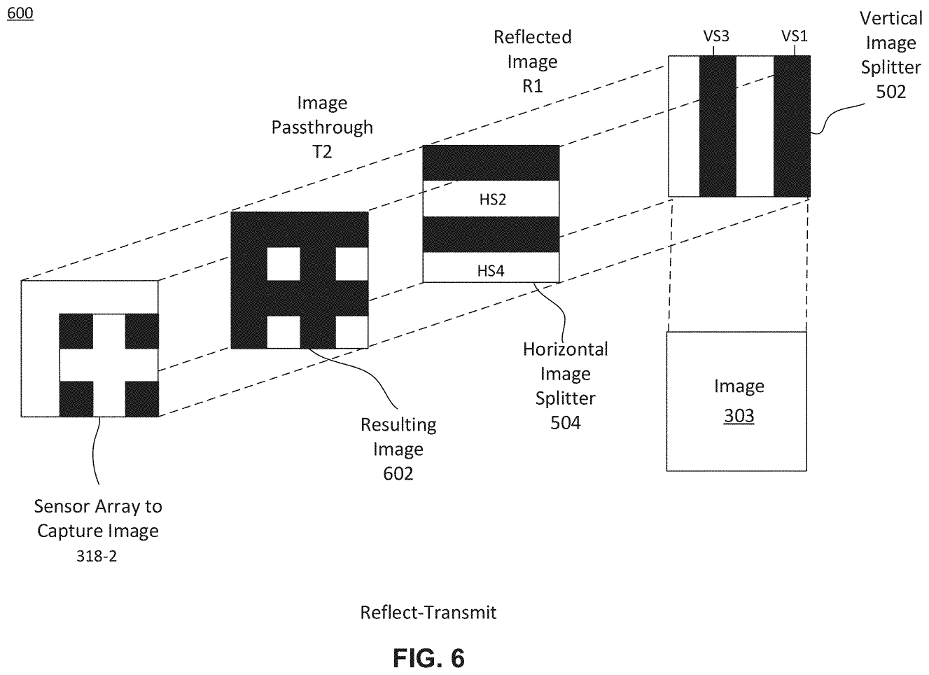

FIG. 6 depicts an illustration of an example reflect-transmit partial image capture, according to some embodiments. An image path includes various splitters (located on transparent structures as described in association with FIGS. 1A, 1B and 2) where it is split by reflection or transmission. In the example embodiment, a plurality of four stripe image splitters (two reflective stripes and two transmissive stripes) segment the image into 16 partial images (squares). Four sensor arrays each capture four of the sixteen partial images (squares) as will be discussed in greater detail hereafter.

As shown, an optical path is formed from image 303 emanating from the back of a camera lens (not shown) to a sensor array 318-2 with one reflection phase R1 and one transmit (pass-through) phase T2, as shown in FIG. 3 and FIG. 4.

Image 303 is incident on a surface of vertical image splitter 502. The function of this splitter is to split the image into four vertical portions. However, only image portions incident on two reflective vertical stripe patterns (VS1 and VS3) are reflected from the splitter and form a first reflected image R1. In this case, when reflected, the image is flipped on the vertical axis.

Reflected vertical stripe image portions (VS1 and VS3) are subsequently split as they become incident on horizontal image splitter 504. However, only image portions incident on the two transmissive horizontal stripe patterns (HS2 and HS4) pass-though the splitter and form an image pass-through T2. Because of the single reflection, the image remains flipped on the vertical axis.

Each of the four resulting image squares shown as resulting image 602 are based on the intersection of VS1 and VS3 with HS2 and HS4. These four partial images are formed on sensor array 318-2. As such, a total of a quarter of the image is captured on these four sensors, one-sixteenth of the image each.

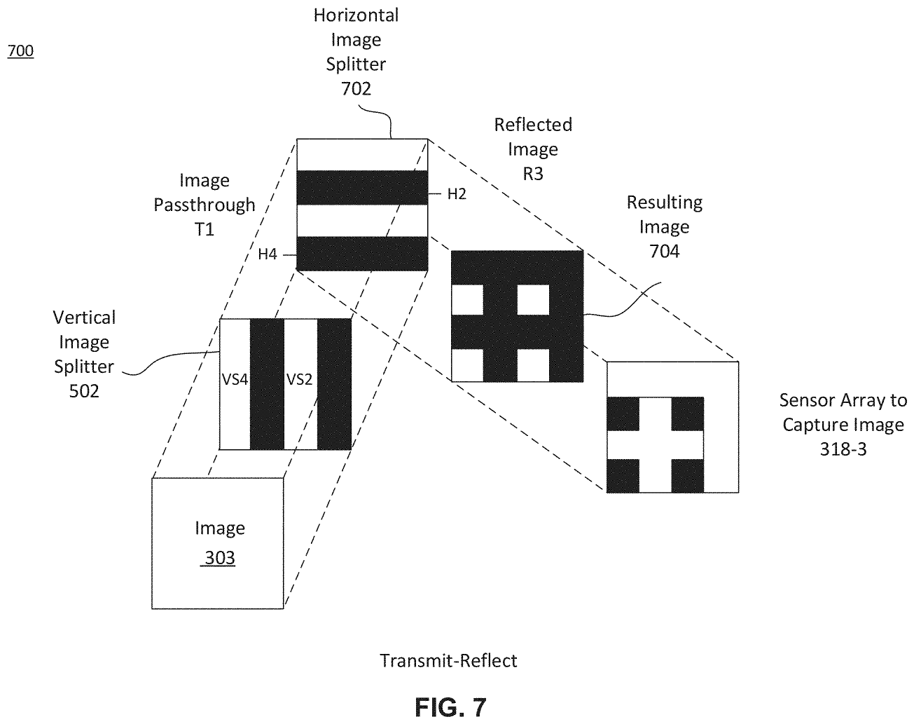

FIG. 7 depicts an illustration of an example transmit-reflect partial image capture, according to some embodiments. The image path includes various splitters (located on transparent structures as described in association with FIGS. 1A, 1B and 2) where it is split by reflection or transmission. In the example embodiment, a plurality of four stripe image splitters (two reflective stripes and two transmissive stripes) segments the image into 16 partial images (squares). Each of the four sensor arrays capture four of the sixteen partial images (squares) as will be discussed in greater detail hereafter.

As shown, an optical path is formed from image 303 emanating from the back of a camera lens to a sensor array 318-3 with one transmit (pass-through) phase T1 and one reflect phase R3 as shown previously in FIG. 3 and FIG. 4.

The image is transmitted to vertical image splitter 502 comprising alternating vertical reflective and clear stripe patterns. The function of this splitter is to split the image into four vertical image portions. However, only image portions incident on the two clear (transmissive) vertical stripe patterns (VS2 and VS4) pass-though the splitter and form a first image pass-through T1. Vertical stripe patterns (VS2 and VS4) are subsequently split as they become incident on horizontal image splitter 702. However, only image portions incident on the two reflective horizontal stripe patterns (HS2 and HS4) reflect from the splitter and form reflected image R3. Because of the single reflection, the final image is flipped on the vertical axis.

Each of the four squares in resulting image 704 are based on the intersection of VS2 and VS4 with HS2 and HS4. These four partial images are formed on sensor array 318-3. As such, a total of a quarter of the image is captured on these four sensors, one-sixteenth of the image each.

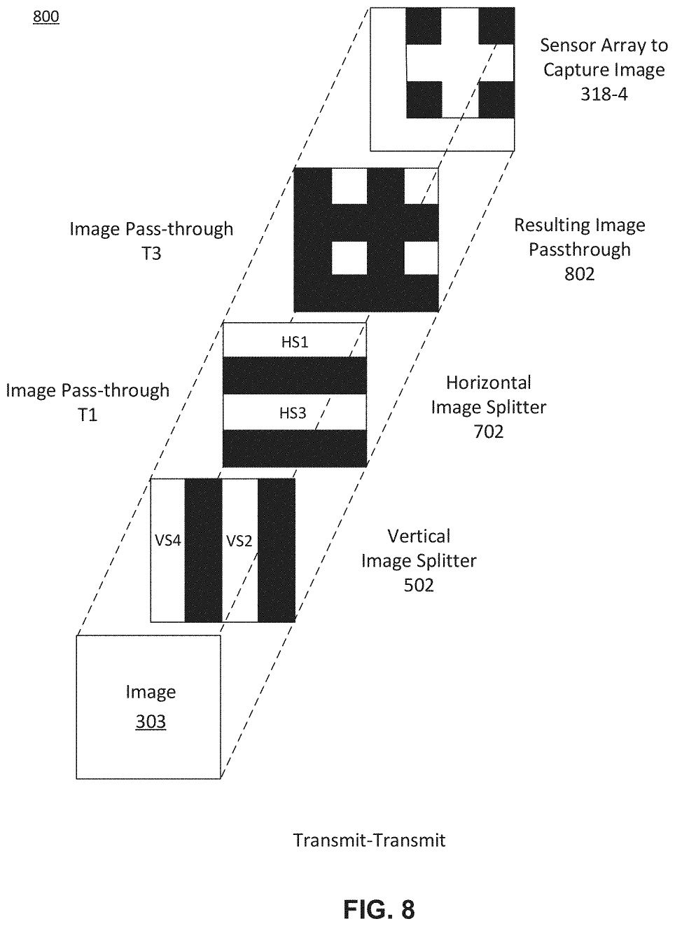

FIG. 8 depicts an illustration of an example transmit-transmit partial image capture, according to some embodiments. The image path as it encounters various splitters (located on transparent structures as described in association with FIGS. 1A, 1B and 2) is repeatedly split by reflection or transmission. In the example embodiment, a plurality of four stripe image splitters (two reflective stripes and two transmissive stripes) segments the image into 16 partial images (squares). Each of the four sensor arrays capture four of the sixteen partial images (squares) as will be discussed in greater detail hereafter.

As shown, an optical path is formed from an image 103 emanating from the back of a camera lens to a sensor array 318-4 with two transparent structure transmit (pass-through) phases T1 and T3 as shown previously in FIGS. 3, and 4.

Image 303 is transmitted to vertical image splitter 502 comprising alternating vertical reflective and clear stripe patterns. The function of this splitter is to split the image into four vertical image portions. However, only image portions incident on the two transmissive vertical stripe patterns (VS2 and VS4) pass-though the splitter and form a first image pass-through T1. Vertical stripe patterns (VS2 and VS4) are subsequently split as they become incident on horizontal image splitter 702. However, only image portions incident on the two transmissive horizontal stripe patterns (HS1 and HS3) pass-though the splitter and form a second image pass-through T2. This image retains its original orientation.

Each of the four pass-through squares in resulting image pass-through 802 are based on the intersection of VS2 and VS4 with HS1 and HS3. These four partial images are formed on sensor array 318-4. As such, a total of a quarter of the image is captured on these four sensors, one-sixteenth of the image each.

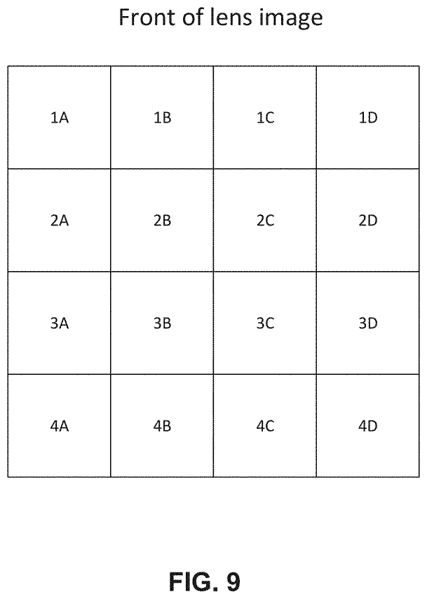

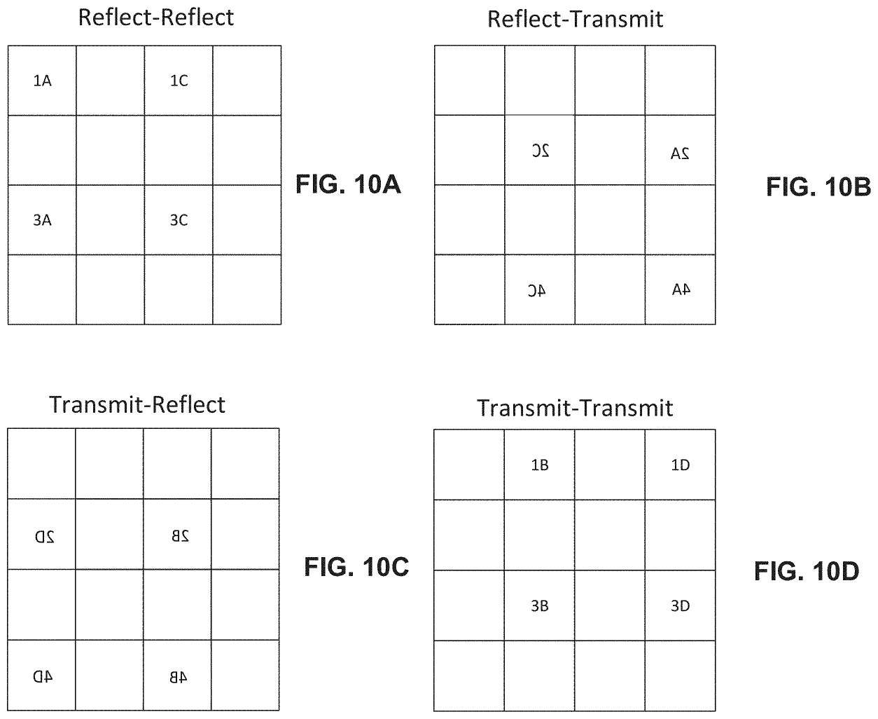

FIG. 9 depicts an image of interest located in image plane 301 as shown, for example in FIG. 3. As shown, the image has been segmented into sixteen squares reflecting the three-striped splitter, four-strip (two reflective, two transmissive) embodiment as shown throughout the figures. This image enters the camera lens in a standard orientation. From this original image, we can trace these partial image segments as they are split multiple times until they are finally captured as non-contiguous segments by sensor arrays 318 (1-4). FIGS. 10A-10D show a distribution and orientation of these segments captured in individual arrays (4 squares).

FIG. 10A depicts segments of the image of interest as they are captured on sensor array 318-1. In this optical path, the original image is reflected twice thus reverting back to its original orientation.

FIG. 10B depicts segments of the image of interest as they are captured on sensor array 318-2. In this optical path, the original image is reflected once thus flipping the original image on the vertical axis.

FIG. 10C depicts segments of the image of interest as they are captured on sensor array 318-3. In this optical path, the original image is reflected once thus flipping the original image on the vertical axis.

FIG. 10D depicts segments of the image of interest as they are captured on sensor array 318-4. In this optical path, the original image retains its original image orientation.

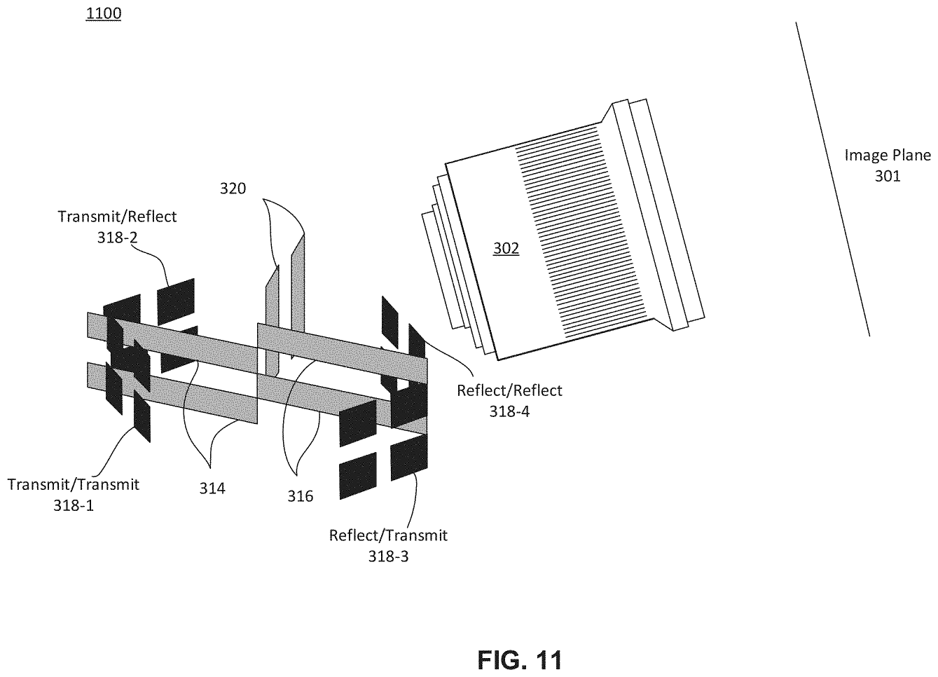

FIG. 11 depicts an illustration of a system 1100 for splitting an image to be captured by multiple sensors, according to some embodiments. In this 3D visualization (back corner view), the transparent triangular structures have been omitted to illustrate spatial relationships of the reflective striping and four array sensors 318 (1-4). Lens 302 receives an image from image plane 301 and outputs an image from the back of the lens.

A mirrored (reflective) layer with alternating transmissive areas is created by vertical mirror stripes 320 oriented 315 degrees from the optical axis of the lens. For illustration purposes, the stripes are depicted as separate from the transparent structures. However, in practice they are applied directly to a surface through a known coating process, such as by lithography.

A second mirrored (reflective) layer with alternating transmissive areas is created by horizontal mirror stripes 316 oriented 45 degrees from the optical axis of the lens and 90 degrees offset from the vertical mirror stripes 320. For illustration purposes, the stripes are depicted as separated from a surface of the transparent structure. However, in practice they are applied directly to a surface through a coating process, such as by lithography.

A third mirrored (reflective) layer with alternating clear (transmissive) areas is created by horizontal mirror stripes 314 oriented 45 degrees from the optical axis of the lens and 270 degrees offset from the vertical mirror stripes 320. For illustration purposes, the stripes are depicted as separated from the transparent structure. However, in practice they are applied directly to a surface through a coating process, such as by lithography.

Sensor arrays 318 (1-4) are arranged at or near intersecting outward ends of the horizontal stripes 314 and 316.

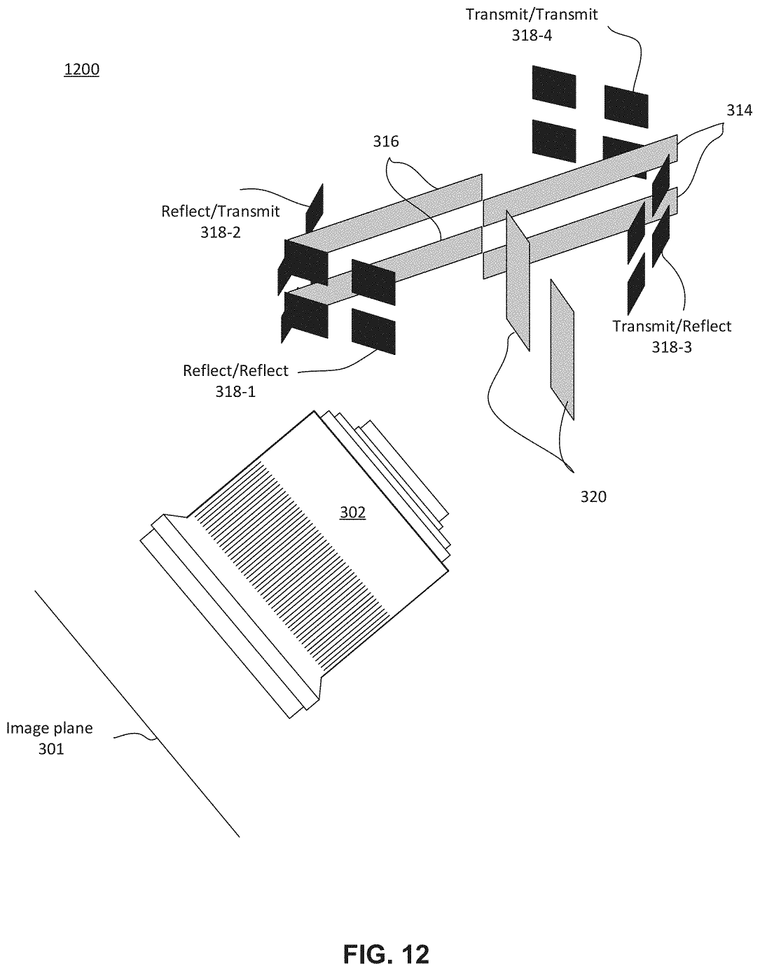

FIG. 12 depicts an illustration of a system for splitting an image to be captured by multiple sensors, according to some embodiments. In this 3D visualization (front corner view), the transparent triangular structures have been omitted to illustrate spatial relationships of the reflective striping and four array sensors 318 (1-4). Lens 302 receives an image from image plane 301 and outputs an image from the back of the lens.

A mirrored (reflective) layer with alternating transmissive areas is created by vertical mirror stripes 320 oriented 315 degrees from the optical axis of the lens. For illustration purposes, the stripes are depicted as separate from the transparent structure. However, in practice they are applied directly to a surface through a known coating process, such as by lithography.

A second mirrored (reflective) layer with alternating transmissive areas is created by horizontal mirror stripes 316 oriented 45 degrees from the optical axis of the lens and 90 degrees offset from the vertical mirror stripes 320. For illustration purposes, the stripes are depicted as separated from the transparent structure. However, in practice they are applied directly to a surface through a coating process, such as by lithography.

A third mirrored (reflective) layer with alternating transmissive areas is created by horizontal mirror stripes 314 oriented 45 degrees from the optical axis of the lens and 270 degrees offset from the vertical mirror stripes 320. For illustration purposes, the stripes are depicted as separated from the transparent structure. However, in practice they are applied directly to a surface through a coating process, such as by lithography.

Sensor arrays 318 (1-4) are arranged at or near intersecting outward ends of the horizontal stripes 314 and 316.

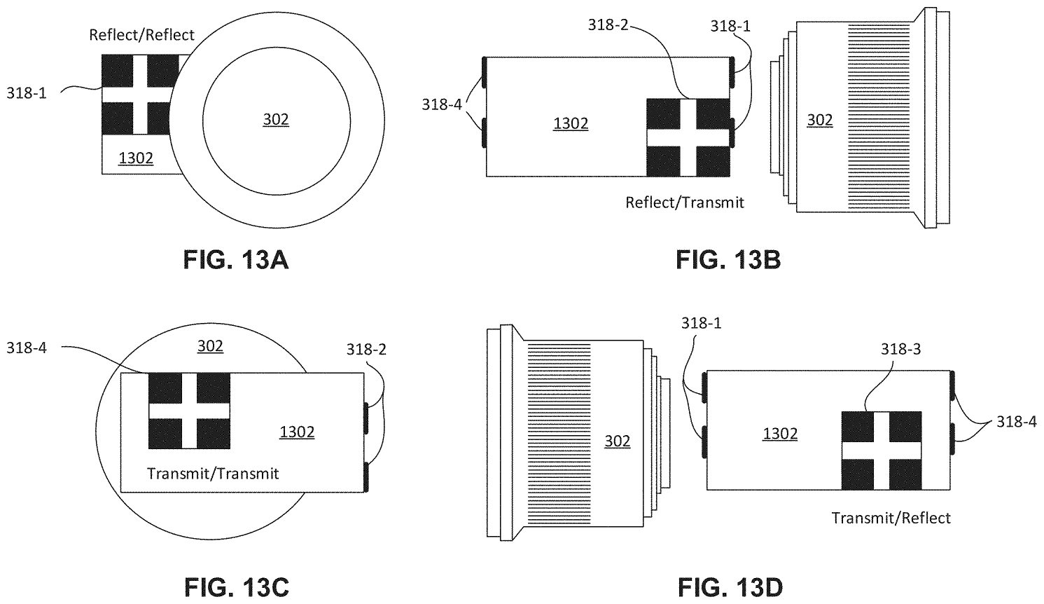

FIGS. 13A-13D depict sensor positions for a system splitting an image to be captured by multiple sensors, according to some embodiments.

Image splitter system 1302 includes four mounted printed circuit boards (PCBs), each with four sensors. The PCBs are adhered or mounted using known attachment methods. In addition, while shown as square PCBs, the PCBs may be of any shape and may include additional board real estate not shown for housing various electronics to support the sensor arrays. Alternately, the individual sensors can be mounted directly to the glass structures and wired to one or more separate PCBs.

As shown in FIG. 13A, sensor array 318-1 (reflect-reflect) is justified in an upper left-hand corner of a front face of image splitter system 1302. The sensors have a bezel size that is less than one-half of the active sensor area. An array of any number of sensors can be used in this design. The sensors are mounted such that the vertical spacing edge-to-edge between sensors is slightly less than the vertical height of the active area of the sensor.

As shown in FIG. 13B, sensor array 318-2 (reflect-transmit) is justified in a lower right-hand corner of a side face of image splitter system 1302. The sensors have a bezel size that is less than one-half of the active sensor area. An array of any number of sensors can be used in this design. The sensors are mounted such that the vertical spacing edge-to-edge between sensors is slightly less than the vertical height of the active area of the sensor.

As shown in FIG. 13C, sensor array 318-4 (transmit-transmit) is justified near an upper left-hand corner of a back face of image splitter system 1302. The sensors have a bezel size that is less than one-half of the active sensor area. An array of any number of sensors can be used in this design. The sensors are mounted such that the vertical spacing edge-to-edge between sensors is slightly less than the vertical height of the active area of the sensor.

As shown in FIG. 13D, sensor array 318-3 is justified in a lower center position of a side face of image splitter system 1202. The sensors have a bezel size that is less than one-half of the active sensor area. An array of any number of sensors can be used in this design. The sensors are mounted such that the vertical spacing edge-to-edge between sensors is slightly less than the vertical height of the active area of the sensor.

In some instances, light passing by very thin edges (edges of reflective stripes) bends around the edge and causes chromatic aberration where the colors separate out into their component parts at the edge of the shadow. This may lead to lower color fidelity at the seams between sensors or even a small amount of lost pixel data. AI gap filling may be employed in an image-processing pipeline to interpolate the transition between different portions of the image. Gap filling is an established branch of AI image processing covering imperfections in the image in the space between sensors.

One improvement provided by the technology described herein is a lens with an image circle larger than the sensors themselves can be divided up to hit multiple smaller sensors.

Another improvement provided by the technology described herein is that only a single lens with a single nodal point is required to combine the images from each sensor into one seamless image. Current ultra-high resolution systems, using available sensors, require time-consuming manual image warping and stitching because each lens has a different perspective of the scene and therefore include parallax differences between foreground and background objects.

As may be used herein, the terms “substantially” and “approximately” provide an industry-accepted tolerance for its corresponding term and/or relativity between items. Such an industry-accepted tolerance ranges from 90-100 percent and corresponds to, but is not limited to, component values, component variations, or optical reflection/transmission values. Such relativity between items ranges from a difference of a few percent to magnitude differences.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. For example, for non-rectangular sensors, as long as they tessellate, a camera system may be created by recreating these shapes. For example, hexagonal sensors with hexagonal mirror and transparent areas would also tile, though they may, in some embodiments, require more splits to avoid the bezels.

The foregoing description of the specific embodiments will reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An optical image splitter, comprising:
a first image splitter, including a plurality of first reflective patterns interleaved with a plurality of first transmissive patterns, configured to split an image into a plurality of first reflected image portions and a plurality of first transmitted image portions;
a second image splitter, including a plurality of second reflective patterns interleaved with a plurality of second transmissive patterns, configured to split the plurality of first reflected image portions into a plurality of second reflected image portions and a plurality of second transmitted image portions;
a third image splitter, including a plurality of third reflective patterns interleaved with a plurality of third transmissive patterns, configured to split the plurality of first transmitted image portions into a plurality of third reflected image portions and a plurality of third transmitted image portions; and
a plurality of sensors configured to capture the plurality of second transmitted image portions, the plurality of second reflected image portions, the plurality of third transmitted image portions and the plurality of third reflected image portions.

2. The optical image splitter of claim 1, wherein the first image splitter and the second image splitter are formed on a first and second surface, respectively, of a first transmissive isosceles right triangle block.

3. The optical image splitter of claim 2, wherein the second image splitter is formed on a surface of a second transmissive isosceles right triangle block.

4. The optical image splitter of claim 3, further comprising:
a third transmissive isosceles right triangle block configured to transmit the plurality of second transmitted image portions to a first portion of the plurality of sensors; and
a fourth transmissive isosceles right triangle block configured to transmit the third transmitted image portions to a second portion of the plurality of sensors.

5. The optical image splitter of claim 1, wherein the plurality of first reflective patterns comprise vertical mirror stripes,
wherein the plurality of second reflective patterns comprise horizontal mirror stripes, and
wherein the plurality of third reflective patterns comprise horizontal mirror stripes.

6. The optical image splitter of claim 1, wherein the plurality of first reflective patterns comprise horizontal mirror stripes, wherein the plurality of second reflective patterns comprise vertical mirror stripes, and wherein the plurality of third reflective patterns comprise vertical mirror stripes divided across a surface of the third image splitter.

7. The optical image splitter of claim 1, wherein the plurality of sensors comprise N² separate sensors, and wherein N represents a combination of the plurality of first reflective patterns and the plurality of first transmissive patterns.

8. The optical image splitter of claim 4, wherein the N² separate sensors comprise N arrays of N separate sensors.

9. The optical image splitter of claim 5, wherein the N arrays of N separate sensors are configured with spacing edge-to-edge between the sensors of less than a vertical height of an active area of the sensors.

10. The optical image splitter of claim 1, wherein the first image splitter is configured with a hypotenuse length related to a desired width of the image and a height that is related to a desired height of the image.

11. The optical image splitter of claim 1, wherein the reflective patterns reflect substantially 100% of an incident image.

12. An optical image splitter comprising:
a first triangular image splitter, including a plurality of vertical reflective patterns interleaved with a plurality of vertical transmissive patterns, configured to split an image into a plurality of first reflected image portions and a plurality of first transmitted image portions;
a second triangular image splitter, including a plurality of first horizontal reflective patterns interleaved with a plurality of first horizontal transmissive patterns, configured to split the plurality of first reflected image portions into a plurality of second reflected image portions and a plurality of second transmitted image portions;
a third triangular image splitter, including a plurality of second horizontal reflective patterns interleaved with a plurality of second horizontal transmissive patterns, configured to split the plurality of first transmitted image portions into a plurality of third reflected image portions and a plurality of third transmitted image portions; and
separate sensors capturing the plurality of second transmitted image portions, the plurality of second reflected image portions, the plurality of third transmitted image portions and the plurality of third reflected image portions as partial images.

13. The optical image splitter of claim 12, wherein the separate sensors comprise N² separate sensors, and wherein N represents a combination of the plurality of first vertical reflective patterns and the plurality of first vertical transmissive patterns.

14. The optical image splitter of claim 12, wherein the first triangular image splitter and the second triangular image splitter are formed on a first and second surface, respectively, of a first transmissive isosceles right triangle block.

15. The optical image splitter of claim 14, wherein the second triangular image splitter is formed on a surface of a second transmissive isosceles right triangle block.

16. The optical image splitter of claim 15, further comprising:
a third transmissive isosceles right triangle block transmitting the plurality of second transmitted image portions to a first portion of the separate sensors; and
a fourth transmissive isosceles right triangle block transmitting the third transmitted image portions to a second portion of the separate sensors.

17. The optical image splitter of claim 11, wherein the reflective patterns reflect substantially 100% of an incident image.

18. An image capture system comprising:
a first three-dimensional transmissive geometric shape with a plurality of vertical reflective and transmissive patterns formed on a first surface and configured to split an incident image into a plurality of first reflected image portions and plurality of first transmitted image portions, and plurality of first horizontal reflective and transmissive patterns formed on a second surface and configured to split the plurality of first reflected image portions into plurality of second reflected image portions and plurality of second transmitted image portions;
a second three-dimensional transmissive geometric shape, coupled to the first three-dimensional transmissive geometric shape, with a plurality of second horizontal reflective and transmissive patterns formed on a third surface and configured to split the plurality of first transmitted image portions into plurality of third reflected image portions and plurality of third transmitted image portions;
a third three-dimensional transmissive geometric shape, coupled to the first three-dimensional transmissive geometric shape, transmitting the plurality of second transmitted image portions;
a fourth three-dimensional transmissive geometric shape, coupled to the second three-dimensional transmissive geometric shape, transmitting the plurality of third transmitted image portions;
separate sensors capturing the plurality of second transmitted image portions, the plurality of second reflected image portions, the plurality of third transmitted image portions, and the plurality of third reflected image portions as partial images; and
whereby the incident image can be reformed by subsequently combining of each of the partial images.

19. The image capture system of claim 18, wherein the separate sensors comprise N² separate sensors, and wherein N represents a total number of the first reflective and transmissive patterns.

20. The image capture system of claim 18, wherein the first, second, third and fourth three-dimensional transmissive geometric shapes comprise isosceles right triangle glass blocks.
